(19) United States
(12) Patent Application Publication
(10) Pub. No.: US 2002/0104313 A1
(43) Pub. Date: Aug. 8, 2002

(54) Hydraulic transformer using a pair of variable displacement gear pumps

(76) Inventor: John M. Clarke, Chillicothe, IL (US)

Correspondence Address: Taylor & Aust, P.C., ATTN: Todd T. Taylor, 142 South Main Street, P.O. Box 560, Avilla, IN, 46710, US

(21) Appl. No.: 09/776,842

(22) Filed: Feb. 5, 2001

(51) Int. Cl. F16D 31/02

(52) U.S. Cl. 60/419

(57) ABSTRACT

A hydraulic transformer for controlling hydraulic fluid pressure and flow to a hydraulic device includes first and second variable flow rate gear pumps supplied with high-pressure hydraulic fluid and low-pressure hydraulic fluid such that the delivery pressure and flow can be controlled, as needed. First gears of the first and second gear pumps are disposed on a common first shaft, and second gears of the first and second gear pumps are disposed on a common second shaft. Relative axial movement between the first and second shafts causes increased or decreased engagement length between the first and second gears of both the first gear pump and the second gear pump.

### TECHNICAL FIELD

The present invention relates to hydraulic systems and, more particularly, to hydraulic pressure transformers for hydraulic systems.

### BACKGROUND ART

Work machines commonly use devices such as hydraulic motors and hydraulic pistons as drive and operating mechanisms. A pump may supply high-pressure fluid to the device. If the device, such as a hydraulic cylinder, is to be operated under low load, it is known to throttle the hydraulic line to lower the pressure of the hydraulic fluid supplied, thereby facilitating control and performance. Lowering the hydraulic fluid pressure by throttling the hydraulic line works well in operating the device, however, resistance created in the line to lower the pressure results in significant energy loss in the hydraulic system.

In some hydraulic systems, a transformer is necessary for the efficient use of hydraulic power to drive wheels or operate cylinders. When the hydraulic system includes a source of hydraulic fluid at a fixed delivery pressure from an accumulator or the like, the transformer can be used to convert the source pressure and flow into nearly equal deliver power having lower pressure and higher flow, or higher pressure and lower flow.

Known hydraulic pressure transformers include a rotatable port block having ports therein for selectively connecting the hydraulic fluid source with a hydraulic fluid delivery line. U.S. Pat. No. 6,092,455 entitled “Hydraulic Pressure Transformer” discloses a transformer of this general type. Such transformers are somewhat complex, and can be expensive to manufacture.

The present invention is directed to overcoming one or more of the problems as set forth above.

### DISCLOSURE OF THE INVENTION

In one aspect of the invention, a hydraulic transformer comprises a variable displacement first gear pump connected to a high-pressure fluid source, and includes a cooperating gear couple having a variable engagement length. A variable displacement second gear pump is connected to a low-pressure fluid source, and includes a second cooperating gear couple having a variable engagement length.

In another aspect of the invention, a hydraulic system comprises a high-pressure fluid source, a low-pressure fluid source, and a transformer. The transformer has a variable displacement first pump connected to the high-pressure fluid source and a variable displacement second pump connected to the low-pressure fluid source. A delivery conduit is connected to receive flow from the variable displacement first pump and from the variable displacement second pump.

In yet another aspect of the invention, a method for providing hydraulic power comprises steps of providing a high-pressure fluid source and a low-pressure fluid source; providing a first gear pump connected to the high-pressure fluid source and a second gear pump connected to the low-pressure fluid source; providing a delivery line connected to receive fluid flow from the first gear pump and from the second gear pump; and adjusting the pumping performance of the first gear pump and the second gear pump to control flow rate and pressure of hydraulic fluid in the delivery line.

### BRIEF DESCRIPTION OF THE DRAWINGS

FIG. 1 is a cross-sectional view of a hydraulic transformer according to the present invention;

FIG. 2 is a schematic representation of a hydraulic system having a hydraulic transformer of the present invention in one operating condition; and

FIG. 3 is a schematic representation of a hydraulic system having a hydraulic transformer of the present invention in a second operating condition.

### BEST MODE FOR CARRYING OUT THE INVENTION

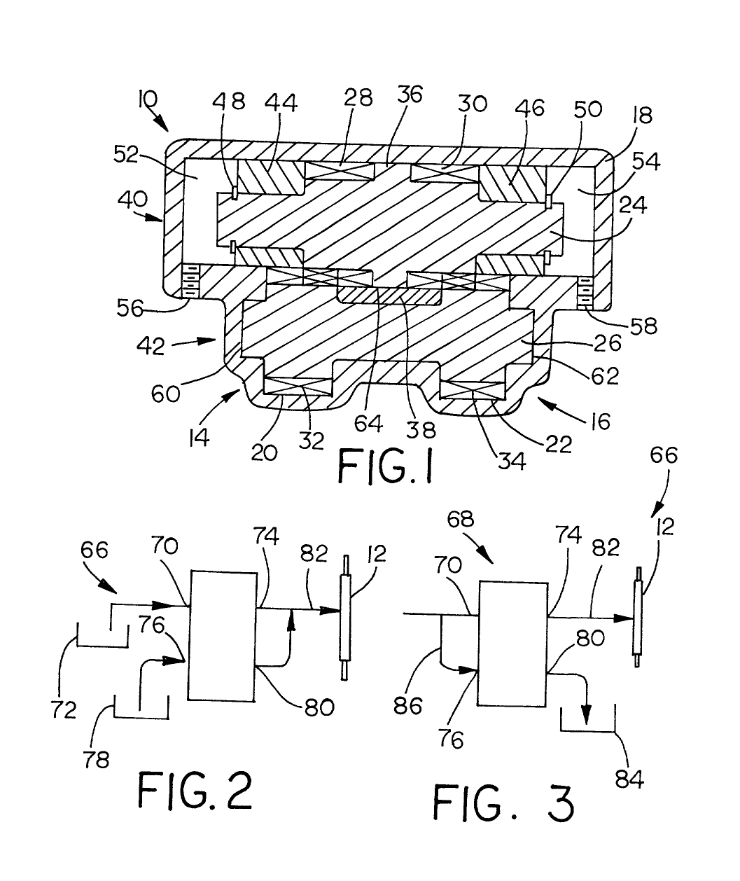

Referring now to the drawings, and more particularly to FIG. 1, there is shown an embodiment of a hydraulic transformer 10 of the present invention. Hydraulic transformer 10 may be used in conjunction with a hydraulic motor, hydraulic piston or the like, collectively referred to herein as a hydraulic device 12, shown in FIG. 2.

Hydraulic transformer 10 includes a first gear pump 14 and a second gear pump 16. Each first gear pump 14 and second gear pump 16 comprises a variable displacement gear pump, as will be described in greater detail hereinafter.

First gear pump 14 and second gear pump 16 are disposed in a common housing 18, which defines a first pumping chamber 20 for first gear pump 14 and a second pumping chamber 22 for second gear pump 16. A first shaft 24 and a second shaft 26 are disposed in housing 18. A first gear 28 of first gear pump 14 and a first gear 30 of second gear pump 16 are disposed on first shaft 24. A second gear 32 of first gear pump 14 and a second gear 34 of second gear pump 16 are disposed on second shaft 26. First gear 28 and second gear 32 of first gear pump 14 are operatively engaged to define a first gear couple disposed in first pumping chamber 20. Gears 28 and 32 engage along a variable axial length, variation in the engagement length occurring from relative axial movement between the gears 28 and 32. First gear 30 and second gear 34 of second gear pump 22 are operatively engaged to define a second gear couple disposed in second pumping chamber 22. Gears 30 and 34 engage along a variable axial length, variation in the engagement length occurring from relative axial movement between the gears 30 and 34.

First gears 28 and 30 of first gear pump 14 and second gear pump 16, respectively, and second gears 32 and 34 of first gear pump 14 and second gear pump 16, respectively, may be individual components disposed on first shaft 24 and second shaft 26. Alternatively, gears 28, 30, 32 and/or 34 may be integral portions of first shaft 24 and second shaft 26 formed by casting, machining or other formation process. The tooth patterns for gears 28, 30, 32 and 34, the number of teeth, configuration and the like may vary in different transformers 10, as is known for common gear pump design.

First shaft 24 includes a collar 36 extending radially outwardly between first gear 28 and first gear 30 of first and second gear pumps 14 and 16, respectively. Collar 36 may be integral with first shaft 24, and extends outwardly at least as far as first gear 28 and first gear 30.

Second shaft 26 defines a valley 38 between second gear 32 and second gear 34 of first gear pump 14 and second gear pump 16, respectively.

Housing 18 defines a first shaft retaining zone 40 and a second shaft retaining zone 42. First shaft 24 is mounted in sealing blocks 44 and 46 disposed at axially opposite ends of first shaft 24, outwardly of first gears 28 and 30, respectively. Sealing blocks 44 and 46 are disposed against outer surfaces of first gears 28 and 30, and may be retained axially on first shaft 24 by locking rings 48 and 50. Sealing blocks 44 and 46 are slidably carried in first shaft receiving zone 40, and provide a hydraulic fluid seal against housing 18 at the perimeter of sealing blocks 44 and 46. The assembly of first shaft 24, first gears 28 and 30, and sealing blocks 44 and 46 is axially slidable in first shaft retaining zone 40. First shaft retaining zone 40 is sufficiently longer than first shaft 24 to define first and second pressure compartments 52 and 54 between the axially end portions of housing 18 and sealing blocks 44 and 46, respectively. A first fluid port 56 is provided in housing 18 to establish fluid access to first pressure compartment 52, and a second fluid port 58 is provided in housing 18 to establish fluid access to second pressure compartment 54.

Second shaft retaining zone 42 defines shoulder areas 60 and 62 for receiving and retaining axially opposite ends of second shaft 26. Second shaft 26 is rotatable but axially constrained in second shaft retaining zone 42.

A seal 64 is disposed in housing 18, between valley 38 and collar 36. Valley 38 and collar 36 are rotatable against seal 64, and against radially outer portions of housing 18. The close associations of collar 36 with housing 18 and seal 64, and of valley 38 with housing 18 and seal 64 provide pumping performance isolation of first gear pump 14 from second gear pump 16.

Ports 56 and 58 are connected to a source of control pressure fluid, not shown, for supplying fluid to and accepting fluid from first pressure compartment 52 and second pressure compartment 54. By pumping fluid into one of and removing fluid out of the other of first pressure compartment 52 and second pressure compartment 54, first shaft 24, together with sealing blocks 44 and 46 and first gears 28 and 30, is caused to slide axially in first shaft retaining zone 40.

First gears 28 and 30 of first and second gear pumps 14 and 16, respectively, are disposed in housing 18 inwardly of second gears 32 and 34 of first and second gear pumps 14 and 16, respectively. Thus, as first shaft 24 is caused to slide axially in first shaft retaining zone 40, one of first gears 28 and 30 is caused to slide toward its mating second gear 32 or 34, and the other of first gears 28 and 30 is caused to slide away from its mating second gear 32 or 34.

FIG. 2 and FIG. 3 are schematic illustrations of hydraulic systems 66 and 68, respectively, which utilize hydraulic transformers 10 of the present invention.

As shown for hydraulic system 66 in FIG. 2, first gear pump 14 has an inlet 70 connected to a high-pressure fluid source 72. First gear pump 14 further includes an outlet 74. Second gear pump 16 includes an inlet 76 connected to a low-pressure fluid source 78. Second gear pump 16 further includes an outlet 80. A delivery conduit 82 receives fluid from outlet 74 of first gear pump 14 and fluid from outlet 80 of second gear pump 16. Delivery conduit 82 delivers hydraulic fluid to hydraulic device 12.

Hydraulic system 68, as shown in FIG. 3, includes hydraulic transformer 10 as described for hydraulic system 66 in FIG. 2, and further includes a fluid sump 84 (FIG. 3). Flow from high-pressure fluid source 72 may be diverted to inlet 76 of second gear pump 16 via a diversion conduit 86.

Industrial Applicability

In use, hydraulic transformer 10 is provided in hydraulic system 66 or hydraulic system 68 for providing controlled flow of hydraulic fluid to hydraulic device 12. Pumping performances of first gear pump 14 and second gear pump 16 can be altered simultaneously by axial movement of first shaft 24. With respect to the view shown in FIG. 1, axial movement of first shaft 24 to the left causes an increased meshed area of first gear 28 and second gear 32 of first gear pump 14. Simultaneously, first gear 30 is moved away from second gear 34, decreasing the length of meshing for first gear 30 and second gear 34 of second gear pump 16. Conversely, axial movement to the right causes a decrease in the length of meshing of first gear 28 and second gear 32 of first gear pump 14 and a simultaneous increase in meshed length between first gear 30 and second gear 34 of second gear pump 16. Axial movement of first shaft 24 in first shaft retaining zone 40 can be effected by pumping a control fluid into or out of first pressure compartment 52 and second pressure compartment 54, via first port 56 and second port 58, respectively. Increasing the axial length of gear teeth meshing increases the pumping performance of either first gear pump 14 or second gear pump 16. Decreasing the axial length of gear teeth meshing decreases the pumping performance of either first gear pump 14 or second gear pump 16. Since the axial length of gear teeth meshing increases for one of gear pumps 14 and 16 as it decreases for the other, the pumping flow rate of one is increased as the pumping flow rate of the other is decreased.

To supply hydraulic fluid to hydraulic device 12 at a pressure less than the supply pressure available from high-pressure fluid source 72, hydraulic transformer 10 is adjusted to decrease the pumping flow rate of first gear pump 14 and to increase the pumping flow rate of second gear pump 16. Flow of high-pressure fluid to delivery conduit 82 is decreased, and flow of low-pressure fluid is increased. Thus, the delivery pressure at delivery conduit 82 will be less than the supply pressure available at inlet 70, and the delivery flow, including the increased flow of low-pressure hydraulic fluid from low-pressure fluid source 78 will be greater than the supply flow available at inlet 70. A system in which the delivery pressure is less than the high-pressure fluid supply pressure, and the delivery flow is greater than the supply flow of high-pressure fluid, is shown in FIG. 2.

FIG. 3 illustrates schematically a system in which a higher delivery pressure is desired, with the delivery flow being less than the supply flow. In the illustration, a portion of the supply flow is diverted through diversion conduit 86 to sump 84 to provide the power to raise the pressure in the other flow.

Using hydraulic transformer 10 of the present invention, the hydraulic flow and pressure available at device 12 can be controlled as required. The transformer uses basic concepts of simple and reliable gear pump designs.

Other aspects, objects and advantages of this invention can be obtained from a study of the drawings, the disclosure and the appended claims.

1. A hydraulic transformer comprising:
a variable displacement first gear pump connected to a high-pressure fluid source and including a cooperating gear couple having a variable engagement length;
a variable displacement second gear pump connected to a low-pressure fluid source and including a second cooperating gear couple having a variable engagement length; and
a delivery conduit receiving fluid flow from said variable displacement first gear pump and from said variable displacement second gear pump.

2. The hydraulic transformer of claim 1 including a housing defining a first pumping chamber for said variable displacement first gear pump and a second pumping chamber for said variable displacement second gear pump.

3. The hydraulic transformer of claim 2, each said first cooperating gear couple and said second cooperating gear couple having an idler gear and a drive gear.

4. The hydraulic transformer of claim 2 having a first shaft and a second shaft disposed in said housing, said first shaft having a first gear of said first gear couple and a first gear of said second gear couple disposed thereon, and said second shaft having a second gear of said first gear couple and a second gear of said second gear couple disposed thereon.

5. The hydraulic transformer of claim 4, said first shaft and said second shaft being axially adjustable relative to each other.

6. The hydraulic transformer of claim 5, one of said shafts being axially constrained in said housing and the other said shafts being axially movable in said housing.

7. The hydraulic transformer of claim 6, said first gears being positioned inwardly of said second gears such that relative axial movement of said shafts decreases axial engagement between one said gear couple and increases axial engagement length between the other said gear couple.

8. The hydraulic transformer of claim 1 including a first shaft and a second shaft, said first shaft having a first gear of said first gear couple and a first gear of said second gear couple disposed thereon, and said second shaft having a second gear of said first gear couple and a second gear of said second gear couple disposed thereon.

9. The hydraulic transformer of claim 8, said first shaft and said second shaft being axially adjustable relative to each other.

10. The hydraulic transformer of claim 9, one of said shafts being axially fixed and the other of said shafts being axially movable.

11. The hydraulic transformer of claim 10, said first gears and said second gears being positioned on said first shaft and said second shaft relative to each other such that relative axial movement of said shafts decreases axial engagement between one said gear couple and increases axial engagement length between the other said gear couple.

12. A hydraulic system comprising:
a high-pressure fluid source;
a low-pressure fluid source;
a transformer having a variable displacement first pump connected to said high-pressure fluid source and a variable displacement second pump connected to said low-pressure fluid source;
a delivery conduit connected to receive flow from said variable displacement first pump and from said variable displacement second pump; and
a hydraulic device connected to said deliver line.

13. The hydraulic system of claim 12, each said variable displacement first pump and said variable displacement second pump being a gear pump having axially adjustable gear teeth engagement length.

14. The hydraulic system of claim 12, including a common housing for said variable displacement first pump and said variable displacement second pump.

15. The hydraulic system of claim 14, including a first shaft disposed in said housing; a first gear from each said variable displacement first pump and from said variable displacement second pump provided on said first shaft; a second shaft disposed in said housing; and a second gear from each said variable displacement first pump and from said variable displacement second pump provided on said second shaft.

16. The hydraulic system of claim 15, one of said first and second shafts being axially fixed and the other being movable axially.

17. The hydraulic system of claim 16, said housing defining a first pressure compartment and a second pressure compartment, and including ports for the flow of control pressure fluid in said first and second pressure compartments, for axially adjusting the position of at least one of said first shaft and said second shaft in said housing.

18. The hydraulic system of claim 17, said first gears on said first shaft being disposed inwardly of said second gears on said second shaft in said housing.

19. The hydraulic system of claim 18, having a hydraulic fluid sump receiving hydraulic fluid flow from said transformer.

20. A method for providing relatively constant hydraulic power to a hydraulic device requiring variable hydraulic fluid pressure supply, said method comprising the steps of:
providing a high-pressure fluid source and a low-pressure fluid source;
providing a first gear pump connected to said high-pressure fluid source and a second gear pump connected to said low-pressure fluid source;
providing a delivery conduit connected to receive fluid flow from said first gear pump and from said second gear pump; and
adjusting the pumping flow rate of said first gear pump and said second gear pump to control flow rate and pressure of hydraulic fluid in said delivery conduit.

21. The method of claim 20, including steps of:
providing a first shaft and a first gear of each said first gear pump and said second gear pump on said first shaft, and a second shaft and a second gear of each said first gear pump and said second gear pump on said second shaft; and
adjusting axially the relative positions of said first shaft and said second shaft.

22. The method of claim 21, said adjusting the pumping flow rate achieved by altering an engagement length of said first gear and said second gear of at least one of said first gear pump and said second gear pump.

23. The method of claim 21, said adjusting the pumping flow rate achieved by altering engagement lengths of said first gear and said second gear of each said first gear pump and said second gear pump.
